(19) United States
(12) Patent Application Publication
(10) Pub. No.: US 2011/0123816 A1
(43) Pub. Date: May 26, 2011

(54) Heat Activatable Adhesives for Increasing the Bond Stability Between Plastic and Metals in Die Casting Components

(76) Inventors: Marc Husemann, Hamburg (DE); Matthias Koop, Norderstedt (DE)

(21) Appl. No.: 12/996,333

(22) PCT Filed: Jul. 3, 2009
(86) PCT No.: PCT/EP09/04819

§ 371 Date: Feb. 1, 2011

(30) Foreign Application Priority Data
Jul. 3, 2008 (DE) 10 2008 031 196.0

(51) Int. Cl. B32B 15/06

(52) U.S. Cl. 428/465; 428/457

(57) ABSTRACT

The invention relates to a component formed from metal, at least in sections, wherein a thermoplastic plastic layer is molded around the metal region at least partially, and wherein an adhesion promoter layer comprised of a heat activatable elastic material is disposed between the plastic layer and the metal region at least in areas, said elastic material being heat activatable at least at the side thereof facing the plastic layer, for making a bonded connection between the metal region and the plastic layer.

This is a 371 of PCT/EP2009/004819 filed 3 Jul. 2009 (international filing date), and claims the priority of German Application No. 10 2008 031 196.0, filed on 3 Jul. 2008.

A method is described for producing a component, the component being composed at least partly of metal, and being surrounded at least regionally by a polymer, there being an adhesion promoter disposed between polymer and metal. The adhesion promoter used is a heat-activatable adhesive.

The method envisages first applying the heat-activatable adhesive to the metal, then injecting on the polymer, with the result that, as a consequence of this operation, the crosslinking reaction of the heat-activatable adhesive is initiated and hence very high bonding strengths can be realized between polymer and metal.

### BACKGROUND OF THE INVENTION

Components produced by the injection molding method are already well established. With this method, in principle, polymeric moldings are fabricated from molding compositions. Injection-molding compositions in powder or granule form, for example, are plastified by an injection molding machine and injected at high pressure into the shape-imparting cavity of the injection mold. Typical injection molding machines consist of an injection unit, comprising a heated cylinder, plungers or screw-plungers, and reservoir vessels and drive assemblies, which meters and plastifies the molding composition and injects it into the closed mold. The injection molding machine further comprises a clamping unit, which closes and opens the mold.

A further advantage of the injection molding process is the ability to combine two or more components in one operation, with both similar and different materials being combined with one another. In this context, reference may be made to the hybrid technique and to the insert and outsert technique, which allows metallic structures to be inserted into an injection mold. This allows metallic structures to be overmolded or surround-molded with thermoplastics by injection.

The insert technique refers to the imbedding of metal parts in moldings. The additional parts, such as thread bushes, are inserted into the mold and then the polymeric molding composition is injected around them. Direct surround injection is performed, for example, on insert parts such as ball bearings, metal sheet supports or electrical components. In terms of weight and volume, the polymer fraction is predominant over the metal.

In contrast to the insert technique, the outsert technique is based on a support board, which is usually metallic and which is inserted into the mold and is required to satisfy exacting requirements in terms of dimensional stability, stiffness and strength. Different functional elements and connecting elements made from polymer, such as bearings, slide rails, snap connections, stops and screw insertions, can then be injected, forming a positive lock, into punched accommodation holes in said support board.

Injection-molded polymer/metal hybrids make synergistic use of the properties of the bond partners involved, thereby allowing rational manufacture of multifunctional lightweight structures. The combination of the advantages of each individual group of materials is the objective when employing this technique. Thus, for example, thin-wall metal sheet profiles can be stiffened by the application of suitable polymeric structures, by combining the advantage of the lower specific weight of the polymeric component with the properties of the metal component that are relevant for the particular application. In order to increase the mechanical robustness of the hybrid structures, the aim should be for optimum transmission and distribution of force between the components. One possibility here is for the polymeric melt to penetrate openings in the metal part and to enter there into a permanent, solid bond.

Generally speaking, components of this kind are used, for example, for producing bodywork parts in automaking, such as front ends, or for metallic pins which are clad in plug housings, and also for electronic switching devices. A new trend lies in their application for cell phones. Here, in recent years, there has been a design trend toward ever flatter models. As a result, the requirements made on the polymers employed are becoming higher and higher. The polymers, as a result, are becoming ever harder. This can be made possible by means of new polymer formulations, or by metal reinforcements within these polymers.

The metal-reinforced materials so urgently required, however, are not so simply produced. With the production methods described above, in the melt at the interface, an interface of polymer, with a temperature well below that of the thermoplastic polymer, is formed at the interface with the metal when the thermoplastic polymer meets the metal. As a consequence of this, a thin skin of rapidly cooled thermoplastic polymer is formed. The adhesion of this layer to the metal, however, is very poor. Subsequently there is a reduction in the volume of the component with accompanying cooling in the injection mold. As a result of the contraction, however, stress is generated in turn, and allows at least partial detachment of the polymer from the metal. As a result there are air inclusions between metal and polymer, which in turn further reduce the adhesion. As a result of this deficient adhesion, it is hardly possible to apply tensile and shearing stresses between polymer and metal.

A further problem is that of differences in coefficients of thermal expansion between metal and polymer. This may be a problem during the production process, since there, in the operation, stress between metal and polymer is built up additionally again. However, it may also represent a problem in application, if different temperatures are applied to the component within a short time, thus giving rise to stresses.

In order to minimize gaps it is prior art to introduce casting compositions based on silicones or epoxy resins into the gaps between metal and polymer. These compositions are able to flow and cure, and also, under optimum conditions, to develop an adhesion between metal and polymer.

It is further prior art to apply hotmelt adhesive to the metal for the purpose of sealing. Here, the hotmelt adhesive adheres to the metal, and the injected polymer subsequently adheres to the hotmelt adhesive. The method, however, possesses the advantage that hotmelt adhesives are not crosslinked and hence have only limited solvent resistance and thermal strength.

The use of thermoplastic coatings for metallic substrates is also known from U.S. Pat. No. 6,494,983. Here, steel containers are provided with a layer of thermoplastic polymer, rather than with a PVC lining. The thermoplastic polymer, however, is not impervious to diffusion, and therefore, when aggressive media are present, may cause corrosion to the underlying metal. For corrosion protection, therefore, the metal is provided with thermoset corrosion inhibitor, but the thermoplastic polymer does not adhere to the thermoset. Accordingly, partly thermoplastic polymer powder is added to the thermoset, with the consequence that, during subsequent polymer coating, an adhesion is developed between the corrosion protection and the polymer.

A development of this form is described in WO 2005 061203. Described therein is a method which provides a thermoplastic adhesion promoter between the polymer and the metal layer. The elasticity of the adhesion promoter is such that stresses between metal and polymer can be compensated and reduced. Moreover, the adhesion promoter has a melting temperature which is the same as or lower than that of the polymer. The thermoplastic adhesion promoter may have one-layer or two-layer construction. The method described, however, already describes inherent disadvantages. For instance, a tendency of the thermoplastics used preferably as adhesion promoters is to absorb water. This leads, during coating with the polymer melt, to the formation of water gas, which in turn gives rise to air inclusions and so minimizes the adhesion between metal and polymer. The thermoplastics, consequently, must be protected from oxygen and moisture by means of an inert gas bell. A further disadvantage, in the case of partial adhesive bonds, is the lack of dimensional stability exhibited by thermoplastic adhesion promoters. Hence the thermoplastic adhesion promoters are present in a melt state, which is associated with a very low viscosity. When the injection molded component then cools, the contraction produces an internal pressure which causes the thermoplastic adhesion promoter to flow out. Moreover, this may result in an uneven distribution of the thermoplastic adhesion promoter. Another disadvantage of the thermoplastic adhesion promoters is their hardness, in order to realize high bonding strengths. This likewise applies to the cited thermosets. This, however, is particularly critical in the cell phone sector. Here, a large number of drop tests are conducted, and so the adhesion promoter between the metal and the polymer assembly ought likewise to have good shock-absorbing and elastic properties.

The disadvantages described make it clear that there is a need for improvement to this kind of injection molding method with metal/polymer assemblies.

### SUMMARY OF THE INVENTION

Surprisingly it has been found that these injection molding methods can be improved significantly using specific heat-activatable adhesives as adhesion promoters between metal and polymer.

A component which outstandingly meets the technological challenges posed is described hereinbelow.

### DETAILED DESCRIPTION

The invention relates to a component formed at least regionally of metal, at least part of the metallic region being surrounded by an injected thermoplastic polymer layer, there being disposed between the polymer layer and the metallic region, at least regionally, a layer of adhesion promoter which is composed, at least on its side facing the polymer layer, of a heat-activatable elastic material, this layer of adhesion promoter effecting a material lock between the metallic region and the polymer layer, the elastic adhesion promoter being composed of
at least 30% but not more than 70% by weight of a natural rubber and/or synthetic rubber component,
at least 30% but not more than 70% by weight of at least one reactive resin component,
the reactive resin component, at temperatures above 120° C., initiating a crosslinking reaction with itself, with other reactive resin components or with the natural rubber and/or synthetic rubber.

Further advantageous embodiments of the invention are also described with the method. In another preferred embodiment of the invention, the reactive resin component possesses the capacity to enter into a chemical reaction with the polymer to be processed by injection molding, as well.

### Heat-Activatable Elastic Adhesion Promoter

The heat-activatable elastic adhesion promoter adhesives may be subdivided into two categories:

a) adhesion promoters based on natural rubbers
b) adhesion promoters based on synthetic rubbers.

For the adhesion promoters based on natural rubber, the natural rubber is ground to a molecular weight (weight average) of not below about 100 000 daltons, preferably not below 500 000 daltons, and additized.

With rubber as a starting material for the adhesion promoter, there are wide possibilities for variation. It is also possible to blend natural rubbers with synthetic rubbers. As natural rubber it is possible in principle to use all available grades, such as, for example, crepe, RSS, ADS, TSR or CV types, according to required levels of purity and of viscosity.

The synthetic rubber or synthetic rubbers may be selected preferably from the group of randomly copolymerized styrene-butadiene rubbers (SBR), butadiene rubbers (BR), synthetic polyisoprenes (IR), butyl rubbers (IIR), halogenated butyl rubbers (XIIR), nitrile rubbers or acrylate rubbers (ACM).

It is of course, however, also possible to use all other natural and synthetic rubbers known to the skilled worker in order to prepare adhesives, of the type listed, for example, in “Handbook of Pressure Sensitive Adhesive Technology” by Donatas Satas (van Nostrand, New York 1989).

In one very preferred form the adhesion promoter is based on nitrile rubber or on nitrile-butadiene rubbers.

Nitrile-butadiene rubbers are available as Europrene™ from Eni Chem, or as Krynac™ and Perbunan™ from Bayer, or as Breon™ and Nipol™ from Zeon. Hydrogenated nitrile-butadiene rubbers are available as Therban™ from Bayer and as Zetpol™ from Zeon. Nitrile-butadiene rubbers are polymerized either hot or cold, with the hot-formulated types generally having a relatively high degree of branching, which is generally beneficial to the bonding strength. These types are preferably part of the adhesion promoter of the invention.

In one very preferred version of the invention, the nitrile rubbers have an acrylonitrile fraction of 18% to 51% by weight. In order to prevent complete phase separation with the reactive resins, the acrylonitrile fraction ought to be greater than 18% by weight, again based on the overall fraction.

A further criterion for the nitrile rubber is the Mooney viscosity. Since a high flexibility must remain ensured for the injection molding process, the Mooney viscosity ought to be below 100 (Mooney ML 1+4 at 100° C.). In order to maximize the dimensional stability of the adhesion promoter, the Mooney viscosity ought to be above 50 (Mooney ML 1+4 at 100° C.). Commercial examples of such nitrile rubbers include, for instance, Nipol™ N917 from Zeon Chemicals.

The carboxyl-, amine-, epoxy- or methacrylate-terminated nitrile-butadiene rubbers may be used as additive components. Such elastomers possess with particular preference a molecular weight M_{w} of <20 000 g/mol and an acrylonitrile fraction of 5% to 30% by weight. In order to obtain optimum blendability, the acrylonitrile fraction ought to be at least greater than 5%, again based on the overall fraction of elastomer.

Commercial examples of such terminated nitrile rubbers include, for instance, Hycar™ from Noveon.

For carboxy-terminated nitrile-butadiene rubbers it is preferred to use rubbers having a carboxylic acid number of 15 to 45, very preferably of 20 to 40. The carboxylic acid number is reported as the figure, in milligrams of KOH, which is needed in order to provide complete neutralization of the carboxylic acid.

For amine-terminated nitrile-butadiene rubbers it is particularly preferred to use rubbers having an amine value of 25 to 150, more preferably of 30 to 125. The amine value relates to the amine equivalents which are determined by titration against HCl in ethanolic solution. The amine value is based on amine equivalents per 100 grams of rubber, but ultimately is divided by 100.

The fraction of the reactive resins in the adhesion promoter is between 70% and 30% by weight. One very preferred group comprises epoxy resins. The molecular weight M_{w} of the epoxy resins varies from 100 g/mol up to a maximum of 10 000 g/mol for polymeric epoxy resins.

The epoxy resins comprise, for example, the reaction product of bisphenol A and epichlorohydrin, epichlorohydrin, glycidyl ester, the reaction product of epichlorohydrin and p-aminophenol.

Preferred commercial examples are, for instance, Araldite™ 6010, CY-281™, ECN™ 1273, ECN™ 1280, MY 720, RD-2 from Ciba Geigy, DER™ 331, DER™ 732, DER™ 736, DEN™ 432, DEN™ 438, DEN™ 485 from Dow Chemical, Epon™ 812, 825, 826, 828, 830, 834, 836, 871, 872, 1001, 1004, 1031 etc. from Shell Chemical, and HPT™ 1071, HPT™ 1079, likewise from Shell Chemical.

Examples of commercial aliphatic epoxy resins are, for instance, vinylcyclohexane dioxides, such as ERL-4206, ERL-4221, ERL 4201, ERL-4289 or ERL-0400 from Union Carbide Corp.

Examples of novolak resins which can be used include Epi-Rez™ 5132 from Celanese, ESCN-001 from Sumitomo Chemical, CY-281 from Ciba Geigy, DEN™ 431, DEN™ 438, Quatrex 5010 from Dow Chemical, RE 305S from Nippon Kayaku, Epiclon™ N673 from DaiNippon Ink Chemistry or Epicote™ 152 from Shell Chemical.

As reactive resins it is additionally possible to use melamine resins, such as Cymel™ 327 and 323 from Cytec, for instance.

As reactive resins it is additionally possible to use terpene-phenolic resins, such as NIREZ™ 2019 from Arizona Chemical, for example.

Furthermore, in another preferred version, the reactive resins used may also include phenolic resins, such as YP 50 from Toto Kasei, PKHC from Union Carbide Corp., and BKR 2620 from Showa Union Gosei Corp., for example. As reactive resins it is additionally possible to use phenolic resole resins, both alone and in combination with other phenolic resins.

As reactive resins it is additionally possible to use polyisocyanates, such as Coronate™ L from Nippon Polyurethane Ind., Desmodur™ N3300 or Mondur™ 489 from Bayer, for example.

In another version of the adhesion promoters, moreover, bond strength enhancing (tackifying) resins are added, very advantageously in a fraction of up to 20% by weight, based on the total mixture of the adhesion promoter.

Tackifying resins for addition that may be used include without exception all known tackifier resins that are described in the literature. Representatives that may be mentioned include the pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins. Any desired combinations of these and additional resins may be used in order to adjust the properties of the resultant adhesive in accordance with requirements. Generally speaking, it is possible to use any resins that are compatible (soluble) with the natural or synthetic rubbers, and reference may be made in particular to all aliphatic, aromatic and alkylaromatic hydrocarbon resins, hydrocarbon resins based on pure monomers, hydrogenated hydrocarbon resins, functional hydrocarbon resins, and natural resins. Express reference is made to the depiction of the state of knowledge in the “Handbook of Pressure Sensitive Adhesive Technology” by Donatas Satas (van Nostrand, 1989).

In order to accelerate the reaction between the reactive resins or between the reactive resins and the natural and/or synthetic rubber it is also possible, optionally, to additize crosslinkers and accelerators into the mixture.

Examples of suitable accelerators include imidazoles, available commercially as 2M7, 2E4MN, 2PZ-CN, 2PZ-CNS, PO505, L07N from Shikoku Chem. Corp., or Curezol 2MZ from Air Products. Additionally suitable as crosslinkers are additions of HMTA (hexa-methylenetetramine). For the crosslinking of epoxides it is also possible to add dicyandiamide. Also suitable are difunctional or polyfunctional maleic anhydrides as crosslinking components.

It is also possible, furthermore, to use amines, especially tertiary amines, for acceleration.

Besides reactive resins it is also possible to employ plasticizers. Here, in one preferred version of the invention, use may be made of plasticizers based on polyglycol ethers, polyethylene oxides, phosphate esters, aliphatic carboxylic esters, and benzoic esters. It is also possible, moreover, to employ aromatic carboxylic esters, relatively high molecular mass diols, sulfonamides, and adipic esters.

Furthermore, optionally, fillers may be added (examples being fibers, carbon black, zinc oxide, titanium dioxide, chalk, hollow or solid glass beads, microbeads of other materials, silica, silicates), and other components that may be added optionally include nucleators, expandants, adhesion-boosting additives and thermoplastics, compounding agents and/or aging inhibitors, in the form, for example, of primary and secondary antioxidants or in the form of light stabilizers.

In a further preferred embodiment, further additives are added, such as, for example, polyvinyl formal, polyacrylate rubbers, chloroprene rubbers, ethylene-propylene-diene rubbers, methyl-vinyl-silicone rubbers, fluorosilicone rubbers, tetrafluoroethylene-propylene copolymer rubbers, butyl rubbers.

Polyvinyl butyrals are available as Butvar™ from Solutia, as Pioloform™ from Wacker, and as Mowital™ from Kuraray. Polyacrylate rubbers are available as Nipol AR™ from Zeon. Chloroprene rubbers are available as Baypren™ from Bayer. Ethylene-propylene-diene rubbers are available as Keltan™ from DSM, as Vistalon™ from Exxon Mobil and as Buna EP™ from Bayer. Methyl-vinyl-silicone rubbers are available as Silastic™ from Dow Corning and as Silopren™ from GE Silicones. Fluorosilicone rubbers are available as Silastic™ from GE Silicones. Butyl rubbers are available as Esso Butyl™ from Exxon Mobil. Polyvinyl formals are available as Formvar™ from Ladd Research.

In a further preferred embodiment, additives are added, such as, for example, thermoplastic materials from the group of the following polymers: polyurethanes, polystyrene, acrylonitrile-butadiene-styrene terpolymers, polyesters, unplasticized polyvinyl chlorides, plasticized polyvinyl chlorides, polyoxymethylenes, polybutylene terephthalates, polycarbonates, fluorinated polymers, such as polytetrafluoroethylene, for example, polyamides, ethylene-vinyl acetates, polyvinyl acetates, polyimides, polyethers, copolyamides, copolyesters, polyolefins, such as polyethylene, polypropylene, polybutene, polyisobutene, and poly(meth)acrylates, for example. The listing makes no claim to completeness.

The bond strength of the adhesion promoters can be enhanced through further targeted additization. Thus, for example, polyimine copolymers or polyvinyl acetate copolymers may also be used as bond strength-enhancing additions.

For use as adhesion promoters, the adhesive formulations described above are in film form or in dissolved form. For handling in the injection molding process, it may be of advantage if the adhesion promoters are coated over the full area of a release paper or a release film. The pressure-sensitive adhesiveness of the adhesion promoter at room temperature is low, and it requires activation by heat. The heat converts the adhesion promoter into the tacky state and, in one very preferred embodiment, initiates a crosslinking reaction of the reactive resins. For the inventive use of the above-described adhesion promoters it is additionally necessary for the adhesion promoter to possess an activation temperature below the melting temperature T_{m,A} of the polymer to be processed by injection molding. The activation temperature is defined as that temperature above which the adhesion promoter exhibits a pressure-sensitive tack. Where the adhesion promoter has only one static glass transition temperature T_{g,A}, this temperature ought likewise to be below the melting temperature T_{m,A} of the polymer to be processed by injection molding. Where the adhesion promoter has two or more static glass transition temperatures T_{g,A}, then in one version at least the lowest static glass transition temperature T_{g,A} ought to be below the melting temperature T_{m,A} of the polymer to be processed by injection molding, but with particular preference at least 2 of the static glass transition temperatures T_{g,A}.

For the inventive process it may be of advantage if the adhesion promoter is punched as a structure in film form on a release film or a release paper. The film thickness of the adhesion promoter in one preferred embodiment is between 10 μm and 10 mm, more preferably between 25 μm and 1 mm.

The adhesion promoters may be prepared from solution or from the melt. For conversion into a structure in film form, it is likewise possible to carry out coating from solution or from the melt.

### Process

The process selected is preferably the hybrid technique or the insert technique and also outsert technique in injection molding. An example of machines that can be used for the reaction is the Arburg Allrounder V.

In a first step, the metal parts are provided with the heat-activatable adhesion promoter. In one embodiment the metal parts are provided, for example, over their whole area with the heat-activatable adhesion promoter. In the case of flat components, for example, this may be done using a heated-roll laminator. Also conceivable, furthermore, are heating presses or, in a manual form, irons. In principle it is possible to use any device capable of applying temperature and pressure. In a particularly preferred form, the heat-activatable adhesion promoter is present on a release paper or a release film. Following heat activation, the adhesion promoter then adheres to the metal component. Depending on design, it may then be necessary for the components to be punched again before they are used in the injection molding process. Before the metal part equipped with the adhesion promoter is surrounded with the polymer by injection, any release paper or release film still present must be removed from the adhesion promoter.

In a further embodiment, the heat-activatable adhesion promoter is punched out beforehand, as a structure in film form, which is then applied, as a punched film, to the metal component. Again, for this operation of application, heat and pressure are needed. In a further form, the heat-activatable adhesion promoter is applied from solution. In this scenario, in the simplest case, the metal component is immersed into a solution of the heat-activatable adhesion promoter and is subsequently freed from the solvent in a drying operation. The operation, however, may also take place in a controlled way, by spray coating or knife coating.

All application methods ought to apply only a minimum amount of heat energy, in order to prevent the crosslinking reaction of the reactive resins being initiated in this step already. In certain cases it may even be sufficient for the heat-activatable adhesion promoter to be placed on, without heat, such that it lightly adheres.

The thickness of the layer of heat-activatable adhesion promoter applied to the metallic region varies as a function of the particular application, and may lie between 10 μm and several millimeters; in any case, the thickness ought to be selected such that, during the injection molding operation of the thermoplastic polymer, the adhesion promoter, on the side facing the polymer and the metal, is supplied with an amount of heat which is sufficient for heat activation, in order to allow optimum adhesion between metal, adhesion promoter layer, and thermoplastic polymer.

Following application, the metal components provided at least regionally with heat-activatable adhesion promoter are surround-injected with thermoplastic polymers. Possible thermoplastic polymers for the injection molding process include, for example, polystyrene, polymers of styrene-acrylonitrile (SAN), acrylic-butadiene-styrene (ABS), styrene-butadiene-styrene (SBS), acrylonitrile-styrene-acrylonitrile (ASA), nylon 6, nylon 6,6, polybutadiene terephthalate, polyoxymethylene, polyphthalamide (PPA), polyarylamide, polycarbonate, polycarbonate/ABS blends, polyacetal, polyurethane, polypropylene, polyethylene, polymethyl methacrylate, polyethylene terephthalate, and polyvinyl chloride.

The thermoplastic polymers may also be filled with up to 60% of glass fibers or other fillers.

The process of surround-injecting with thermoplastic polymers introduces heat. As a result of this temperature the heat-activatable adhesion promoter is heat-activated and immediately develops adhesion to the thermoplastic polymer. Furthermore, as a result of the introduction of heat, there is also an increase in the adhesion to the metal component. As a result of the heat, the crosslinking reaction is initiated and the adhesion is increased further. As a further advantage, the dimensional stability is retained, by virtue of the composition selected for the heat-activatable adhesion promoter. One reason for this is the high elastic component provided by the rubber or rubbers. As a result of the high dimensional stability, the adhesion promoter cannot spread in an uncontrolled way. The dimensional stability is retained even under pressure. As a result of the contraction of the thermoplastic polymer with cooling, a high pressure is developed and acts on the adhesion promoter. In a further possible embodiment, the reactive groups of the adhesion promoter may also, with the heat, enter into reactions between the thermoplastic polymer and the adhesion promoter. For this embodiment, the thermoplastic polymer ought preferably to contain reactive groups, such as epoxy, hydroxyl, acid anhydrides or amines/amides, for example. The reactive resin of the adhesion promoter must then be selected accordingly, to allow it to enter into a chemical bonding reaction.

Furthermore, the adhesion promoter may likewise develop an opposing pressure to the contraction of the thermoplastic polymer. This may be the case, for example, for adhesion promoters which comprise, as a reactive resin component, phenol or phenol/resole resins, which are then reacted, for example, with HMTA. In this case, one of the products of the crosslinking reaction is water, which at temperatures above 100° C., in the form of steam, generates a high pressure. This may be of advantage if the desire is to minimize the contraction of the thermoplastic polymer in the injection molding process. The components are pressed more firmly into the mold parts, and there is a more intense development of adhesion between the individual components.

A further advantage of the adhesion promoters used in this process lies in the subsequent thermal reaction. Thus the possibility exists that, on subsequent thermal exposure, the crosslinking reaction will be reinitiated and hence the crosslinking will continue over a longer period of time, and, within the component, the adhesion to the polymer side and to the metal will be further increased.

Another advantage lies in the elastic nature of the adhesion promoter. As a result of the selected chemical composition, a shock-absorbing effect may be taken on in addition to the adhesion promoter function. Hence, particularly with a combination of metal and relatively hard and brittle thermoplastic polymers, the adhesion promoter may take on a shock-absorbing effect under shock loads. Correspondingly, the components can be stressed more greatly in subsequent use. Hence, the adhesion promoter produces not only a shearing and tensile force-increasing effect, but also an increase in the shock resistance. This may be of advantage in automotive applications, where injection-molded components of this kind are required to absorb a relatively large number of impacts, and to do so across a wide range of service temperatures as well. Advantages also exist, however, for casing applications in electronic components of consumer products. These components as well are used across a wide temperature range and may be required to compensate severe shock effects, as when dropped, for example. Here, with the process described, it is readily possible to increase the shock-absorbing capacity of such components and at the same time to realize improved adhesion between polymer and metal.

In order to achieve a further increase in the bond strength between thermoplastic polymer and metal part, it is common practice to provide the metal parts with an opening and/or recess into or through which the plastified polymer is able to penetrate during the injection-molding operation, thus additionally forming a positive lock. In addition to the increased effort and associated higher costs for the fabrication of metal constructions of this kind, this method frequently exhibits weaknesses, particularly with regard to the dimensional stability of the metal components. Given that the recesses/openings, for economic reasons, are usually realized in punching or embossing operations, instances of deformation of the metal structure are frequent, and this may lead to problems with regard to the exact positioning of the component in the injection mold and also in the subsequent end application. In many cases, the use of the adhesion promoter of the invention makes it possible to reduce the number of structural openings required or to do without them completely.

Particularly if thin-wall metal sheet constructions or very fine metal constructions are to be given a polymer surround by injection, the high injection pressure of the thermoplastic polymers frequently results in unwanted deformation/shifting of the metal constructions. Through the use of the adhesion promoter of the invention it is possible in many cases to reduce the injection pressure, thereby easing the mechanical load on the metal structures and making them significantly more stable in their dimensions.

### BRIEF DESCRIPTION OF THE DRAWINGS

FIG. 1 illustrates a test method for a drop test in an embodiment of the present invention.

FIG. 2 illustrates a test method for bonding strength test in an embodiment of the present invention.

### EXAMPLES

### Test Methods

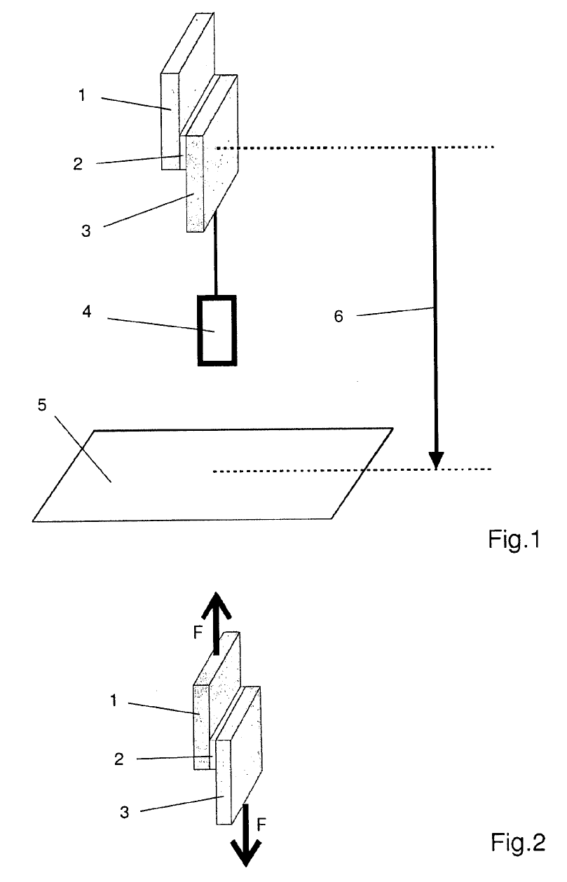

Drop Test A) (cf. FIG. 1)
1=Al plate
2=Heat-activatable film
3=PET plate
4=50 g weight
5=Steel plate
6=Drop height

The bond area between PET and aluminum plate is 2 cm². An Al plate with a thickness of 1.5 mm and a width of 2 cm is bonded to an injected molded PET plate (TEREZ PET 3000, TER Hell Plastic GmbH) having a width of 2 cm and a layer thickness of 3 mm. Subsequently the drop test is carried out. A 50 g weight is attached to the PET plate. The entire assembly is then dropped from different heights onto a steel plate. A determination is made of the height at which the adhesive bond with the heat-activatable adhesion promoter is still able to accommodate the impact, and the Al/PET test specimen does not fall apart. The test, furthermore, is also carried out at different temperatures.

Bonding Strength B) (cf. FIG. 2)
1=Al plate
2=Heat-activatable film
3=PET plate

The bonding strength is determined by means of a dynamic shear test. The bond area is 2 cm². An Al plate with a thickness of 1.5 mm and a width of 2 cm is bonded to an injection molded PET plate (TEREX PET 3000, TER Hell Plastic GmbH) having a width of 2 cm and a layer thickness of 3 mm.

The test specimens are pulled apart at 10 mm/min with a tensile testing machine. The result is reported in N/mm², and represents the maximum force, relative to the bond area, which is measured to part the test specimens (aluminum and PET) from one another. Measurement is made at 23° C. and at 50% relative humidity.

Described below are a number of formulations for the adhesion promoters.

### Example 1

50% by weight of Breon N33 H80 (nitrile rubber, 33% acrylonitrile) from Zeon, 40% by weight of phenol-novolac resin Durez 33040 blended with 8% of HMTA (Rohm and Haas), and 10% by weight of the phenolic resole resin 9610 LW from Bakelite were prepared as a 30% strength solution in methyl ethyl ketone, in a compounder. The kneading duration was 20 hours. The heat-activatable adhesive was subsequently coated from solution onto a glassine release paper, and dried at 100° C. for 20 minutes. After drying, the layer thickness was 100 μm.

### Example 2

25% by weight of Nipol N1094-80 (nitrile rubber) from Zeon, 25% by weight of Breon N33 H80 (nitrile rubber, 33% acrylonitrile) from Zeon, 40% by weight of phenol-novolac resin Durez 33040 blended with 8% of HMTA (Rohm and Haas), and 10% by weight of the phenolic resole resin 9610 LW from Bakelite were prepared as a 30% strength solution in methyl ethyl ketone, in a compounder. The kneading duration was 20 hours. The heat-activatable adhesive was subsequently coated from solution onto a glassine release paper, and dried at 100° C. for 20 minutes. After drying, the layer thickness was 100 μm.

### Lamination:

Examples 1 and 2 were laminated to the aluminum surface using a heated-roll laminator with a roll temperature of 125° C. and an advance velocity of 1 m/min, and with a linear pressure of 2 bar. The bond area was 1×2 cm, the Al strip having a width of 2 cm.

### Reference Example 1

For the bonding operation only the pure PET was bonded to the aluminum.

### Reference Example 2

For the bonding operation, a polyethylene-based thermoplastic hotmelt adhesive was used. The layer thickness was 100 μm. The hotmelt adhesive used was abiflor 1070 from Abiflor AG, based on LDPE, with a melting range of 102-106° C. and with a melt index of 70 g/10 min at 190° C. and 16 kg.

### Adhesive Bonding:

For the adhesive bond, first of all PET from Ter Hell Plastic GmbH (TEREZ PET 3000) was melted. The material was dried in a dry air oven beforehand at 140° C. for 4 hours. It was then melted with a hotplate at 280° C. A PET plate with a width of 2 cm, a length of 8 cm and a layer thickness of 3 mm was formed by means of a special mold, with pressure exerted by a Burkle press. Subsequently, at 5 bar, the Al plate (1.5 mm thick, 2 cm wide, 8 cm long, adhesion promoter bond area 2 cm², bond overlapping and endwise) was applied with example 1 or 2 or reference example 1 or 2 to the PET plate (see Lamination). The pressing operation took place at 265° C. over 5 seconds. This was followed by cooling under pressure (5 bar). Following adhesive bonding, the side edges were cleaned mechanically to remove any overflowing adhesion promoter or PET polymer, so that the only contributor to adhesive bonding is the overlapping area of 2 cm² of the adhesion promoter or without adhesion promoter or with thermoplastic adhesion promoter.

### Results:

The heat-activatable adhesion promoters 1 and 2 were tested analogously with two reference examples 1 and 2. As reference example 1, no adhesion promoter was used. Reference example 2 was an adhesion promoter based on a thermoplastic. All examples were activated under identical conditions.

Following adhesive bonding, the specimens were subjected to a drop test. The results are set out in table 1. The respective drop height is reported in cm.

TABLE 1

| Examples | Test method A at rt | |
|---|---|---|
| Reference 1 | 45 | cm |
| Reference 2 | 80 | cm |
| 1 | 150 | cm |
| 2 | >200 | cm |

From table 1 it is evident that inventive examples 1 and 2 exhibit a significantly better shock resistance, which is reflected in turn in the greater drop height.

Additionally, the bond strengths were measured for the examples. The results are set out in table 2.

TABLE 2

| Examples | Test method B at 23 | |
|---|---|---|
| Reference 1 | 0.7 | N/mm² |
| Reference 2 | 1.3 | N/mm² |
| 1 | 4.2 | N/mm² |
| 2 | 3.8 | N/mm² |

From table 2 it is evident that inventive examples 1 and 2 exhibit the highest dynamic shear strength.

We claim:

1. A component formed at least regionally of metal, at least part of the metallic region being surrounded by an injected thermoplastic polymer layer, there being disposed between the polymer layer and the metallic region, at least regionally, a layer of adhesion promoter which is composed, at least on its side facing the polymer layer, of a heat-activatable elastic material, this layer of adhesion promoter effecting a material lock between the metallic region and the polymer layer.

2. The component according to claim 1, wherein the elastic adhesion promoter is composed of
at least 30% but not more than 70% by weight of a natural rubber and/or synthetic rubber component,
at least 30% but not more than 70% by weight of at least one reactive resin component,
the reactive resin component, at temperatures above 120° C., initiating a crosslinking reaction with itself, with other reactive resin components or with the natural rubber and/or synthetic rubber.

3. A method for increasing bond stability between plastic and metal components, the method comprising:
providing at least one metal component;
adhering an elastic adhesion promoter to an area of the at least on metal component, the elastic adhesion promoter is composed of
at least 30% but not more than 70% by weight of a natural rubber and/or synthetic rubber component,
at least 30% but not more than 70% by weight of at least one reactive resin component,
the reactive resin component, at temperatures above 120° C., initiating a crosslinking reaction with itself, with other reactive resin components or with the natural rubber and/or synthetic rubber; and
surrounding the at least one metal component, having the elastic adhesion promoter, with polymer, by injection.
